(19) United States
(12) Patent Application Publication
(10) Pub. No.: US 2006/0261173 A1
(43) Pub. Date: Nov. 23, 2006

(54) Forgery-proof structure for a memory card

(75) Inventor: Chien-Yuan Chen, Taipei (TW)

Correspondence Address: TROXELL LAW OFFICE PLLC, SUITE 1404, 5205 LEESBURG PIKE, FALLS CHURCH, VA, 22041, US

(73) Assignees: Chien-Yuan Chen; Power Digital Card Co., Ltd.

(21) Appl. No.: 11/131,176

(22) Filed: May 18, 2005

(51) Int. Cl. G06K 19/06

(52) U.S. Cl. 235/492

(57) ABSTRACT

A forgery-proof structure for a memory card includes primarily a letter pattern, such as a totem or a word of format, specification, size of storage capacity, or trademark logo, in a protruded shape, a concave shape, or a hollow shape which is directly molded on a casing of a memory card, upon molding the memory card body, so as to prevent a customer from confusion upon purchasing, and to reduce a possibility of copying by unworthy vendors, thereby constituting another kind of forgery-proof function.

### BACKGROUND OF THE INVENTION

(a) Field of the Invention

The present invention relates to a forgery-proof structure for a memory card, and more particularly to a memory card which is provided with a forgery-proof effect.

(b) Description of the Prior Art

As the advancement of technology, proliferation of information, and rapid development of new electronic products, a memory card has become the most convenient product for storing data. The application of the memory card is very broad, including high technology products such as a digital camera, a digital camcorder, etc.

However, a variety of memory cards of different sizes are developed according to different brands, including XD (Xd-Picture Card), MMSD (MultiMedia Secure Digital Card), SD (Secure Digital Card), MMC (MultiMedia Card), CF (CompactFlash Card), MS (Memory Stick Card), and SM (Smart Media Card), which are provided with a compact size, high compatibility, low cost, large storage capacity, fast transmission speed, and confidentiality.

For the plurality of kinds of memory cards on the existing market, usually a labeling tag printed with brand, format, and specification is pasted on a casing of a memory card, or, a bronzing or a printing method is directly employed, upon labeling the existing memory cards.

As shown in FIG. 1, a labeling tag 20 is pasted on a back surface of a memory card body 10, wherein an SD card is used as an example of implementation. The labeling tag is printed with a word of SD and size of storage capacity. Furthermore, a brand or a totem can be printed on the labeling tag 20 so as to enable a customer to clearly identify a format, size of storage capacity, and manufacturer of the memory card bought by the means of the labeling tag 20.

As a sticker, a bronzing, or a direct halftone printing is primarily used for the labeling tag 20 on the memory card body 10, the labeling tag 20 can be easily fallen off or broken under a long term of usage, thereby causing a customer to be unable to clearly identify. Moreover, the labeling tag 20 can be easily switched by an unworthy vendor to tear off the original labeling tag 20 and re-paste with a copied labeling tag 20, thereby causing a loss of right to the customer and even inducing a great loss to the original vendor.

### SUMMARY OF THE INVENTION

The primary object of the present invention is to provide a forgery-proof structure for a memory card wherein a typeface in a protruded shape, a concave shape, a spot shape, or a hollow shape, including a totem or a word of a format, specification, size of storage capacity, or trademark logo of the memory card, is molded on a casing of memory card upon molding the memory card, so as to prevent a customer from confusing upon purchasing and to reduce a possibility of copying by unworthy vendors, thereby constituting another effect of forgery-proof.

Another object of the present invention is to reduce a cost which is increased due to pasting, printing, or bronzing.

Yet another object of the present invention is to prevent the memory card from being scratched by an operation of pasting, printing, or bronzing, and to prevent the memory card from being stained by sweating of hands.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional memory card pasted with a labeling tag.

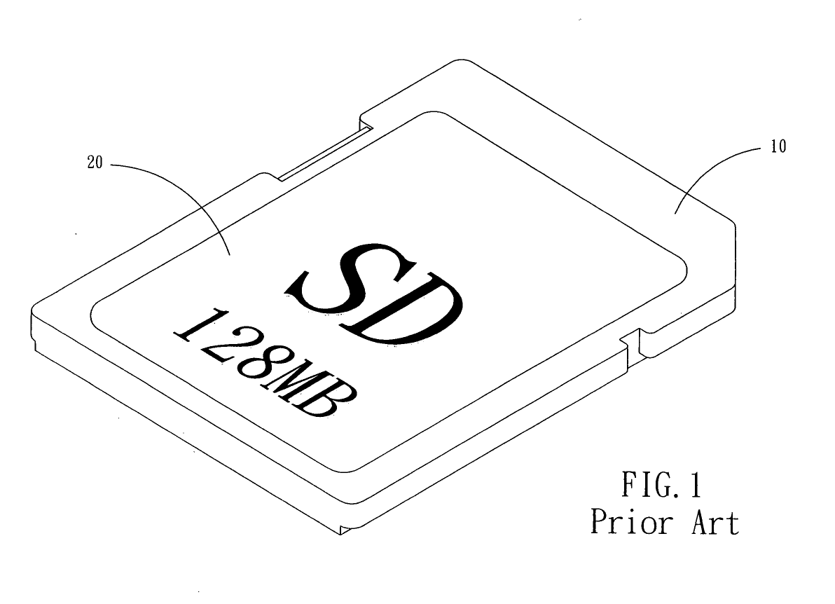

FIG. 2 shows a schematic view of a first implementation of the present invention.

FIG. 3 shows a schematic view of a second implementation of the present invention.

### DETAILED DESCRIPTION OF THE PREFERRED EMBODIMENTS

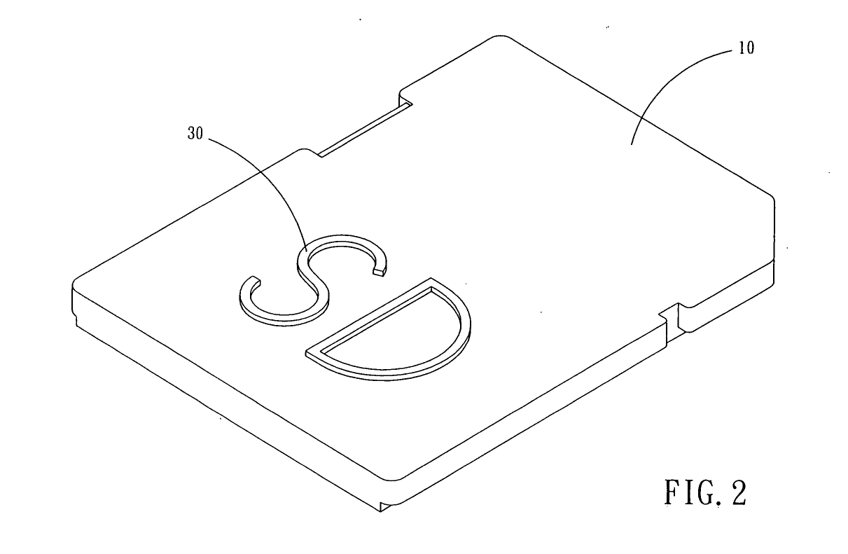

Referring to FIG. 2, the present invention comprises primarily a memory card body 10 on whose surface of casing is provided with a typeface 30 which is directly molded. The typeface 30 can be a totem or a word of format, specification, or storage capacity of the memory card. FIG. 2 shows an example of implementation with the typeface 30 of a format of memory card. In addition, the typeface 30 is directly protruded from a surface of an outer casing of the memory card body 10. Other than the format of memory card, a size of storage capacity can be directly molded on a top of the outer casing along with a logo of manufacturer or company.

Accordingly, upon molding the memory card body 10, the typeface 30 and the outer casing are molded together, so as to directly mold the typeface 30 of a specification, size of storage capacity, and manufacturer on the outer casing. Therefore, a traditional procedure of pasting a labeling tag on or re-processing the outer casing can be replaced, without printing a labeling tag additionally, and the mistakes of operation can be avoided, thereby lowering a cost and improving the drawbacks of falling off of the labeling tag and replacement of the labeling tag by an unworthy vendor, which constitutes another kind of forgery-proof function.

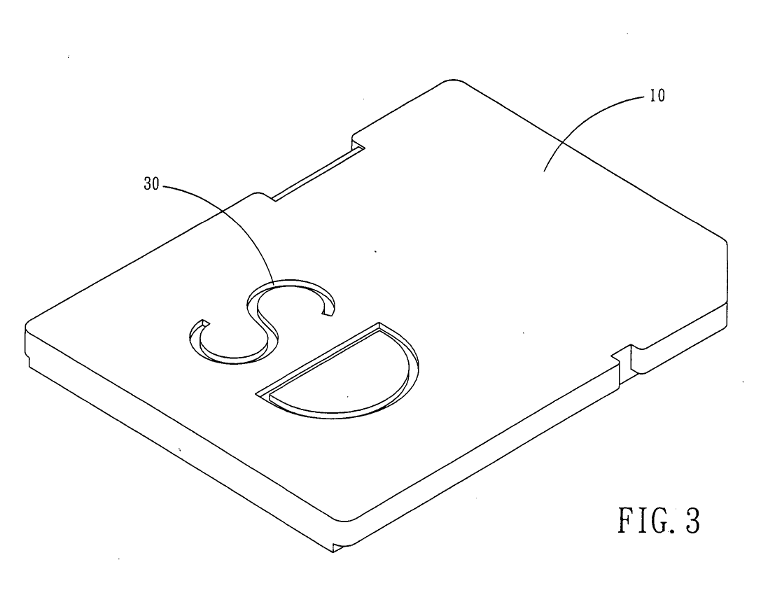

As shown in FIG. 3, other than that the typeface 30 can be protruded on the outer casing of the memory card body 10, a concave shape of dense dots or a hollow shape can be also manifested on the outer casing of the memory card body 10. The typeface 30 disclosed in FIG. 3 is in a concave shape.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A forgery-proof structure for a memory card wherein a typeface of a totem or a word of format, specification, size of storage capacity, and logo of a memory card is directly molded on a surface of an outer casing of the memory card body upon molding the memory card body.

2. The forgery-proof structure for a memory card according to claim 1, wherein the typeface is in a protruded shape, a concave shape, a dot shape, or a hollow shape on the surface of outer casing of the memory card body.
